(19) United States
(12) Patent Application Publication
(10) Pub. No.: US 2015/0042679 A1
(43) Pub. Date: Feb. 12, 2015

(54) APPARATUS, METHOD, COMPUTER PROGRAM AND SYSTEM FOR A NEAR EYE DISPLAY

(71) Applicant: Nokia Corporation, Espoo (FI)

(72) Inventor: Toni Järvenpää, Toijala (FI)

(21) Appl. No.: 14/335,548

(22) Filed: Jul. 18, 2014

(30) Foreign Application Priority Data
Aug. 7, 2013 (GB) 1314120.5

(51) Int. Cl. G06T 19/00

(52) U.S. Cl. CPC G06T 19/006
USPC 345/633

(57) ABSTRACT

Embodiments of the present invention relate to an apparatus, method, computer program and system for a near eye display to cause at least: displaying visual content on a near eye display; detecting an event; and adjusting, in response to detecting the event, a visual prominence of the displayed visual content for altering a viewer's immersion level in the displayed visual content.

### TECHNOLOGICAL FIELD

Embodiments of the present invention relate to an apparatus, method, computer program and system for a near eye display. In particular they relate to an apparatus, method, computer program and system for automatically adjusting a prominence of the presentation of visual content displayed on a near eye display so as to alter a viewer's immersion level in the presented content.

### BACKGROUND

Near Eye Display (NED) devices, including for example Head Mounted Displays (HMD) and displays configured to be wearable by a user/viewer (in forms such as: glasses, goggles or helmets), generally come in two types: ‘see through’ and ‘non-transparent’.

In a ‘see through’ NED, the NED's display region is transparent so that ambient light is able to pass through the display device. A viewer, wearing such a NED, is able to see through the NED to view directly his/her own real world environment/ambient surroundings. Virtual images can be displayed on the NED in a foreground superimposed over the background view of the viewer's real world environment, e.g. such as for augmented reality systems. However, the background view of the viewer's real world environment can affect his/her ability to clearly discern the foreground virtual images being displayed on the NED and can be a distraction to the viewer seeking to view, concentrate and be immersed in displayed content. Accordingly, such NED's may not be optimal for consuming/viewing certain content.

In a ‘non-transparent” NED, i.e. non-see through, the display region is opaque such that ambient light and a view of the viewer's surroundings are blocked from passing through the display region. A viewer, wearing such a NED, is unable to see through the NED and see a large part of his/her own real world environment. A viewer viewing content on the NED could more easily be completely immersed in the presented content and would be oblivious to his/her real world environment. The viewer's ability to see/interact with objects in the real world is thus hindered. Were the viewer desirous of seeing/interacting with real world objects he/she would need to remove the NED. Accordingly, such NED's are not optimal for prolonged use and being worn when not consuming/viewing content.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

Various aspects of examples of the invention are set out in the claims.

According to various, but not necessarily all, embodiments of the invention there is provided an apparatus comprising: at least one processor; and at least one memory including computer program code; wherein the at least one memory and the computer program code are configured to, with the at least one processor, cause at least: displaying visual content on a near eye display; detecting an event; and adjusting, in response to detecting the event, a visual prominence of the displayed visual content for altering a viewer's immersion level in the displayed visual content.

According to various, but not necessarily all, embodiments of the invention there is provided a system comprising the above-mentioned apparatus and a near eye display.

According to various, but not necessarily all, embodiments of the invention there is provided a method comprising causing, at least in part, actions that result in: displaying visual content on a near eye display; detecting an event; and adjusting, in response to detecting the event, a visual prominence of the displayed visual content for altering a viewer's immersion level in the displayed visual content.

According to various, but not necessarily all, embodiments of the invention there is provided a computer program that, when performed by at least one processor, causes the above mentioned method to be performed.

### BRIEF DESCRIPTION OF THE DRAWINGS

For a better understanding of various examples that are useful for understanding the present invention reference will now be made by way of example only to the accompanying drawings in which:

FIG. 1 schematically illustrates an example of an apparatus;

FIG. 2 schematically illustrates an example of a method;

FIG. 3 illustrates an example of a viewer's binocular visual field;

FIG. 4A illustrates an example of viewer's view, via a NED, when no content is being presented;

FIG. 4B illustrates an example of a viewer's view, via a NED, during normal presentation of content;

FIG. 4C illustrates an example of a viewer's view, via a NED, following a triggering event;

FIG. 5 schematically illustrates an example of a display region of a NED;

FIG. 6A schematically illustrates an example of a portion of the display region of FIG. 5;

FIG. 6B schematically illustrates an example of another portion of the display region of FIG. 5; and

FIG. 7 schematically illustrates a further example of an apparatus.

### DETAILED DESCRIPTION

The Figures illustrate an apparatus 100 comprising: at least one processor 102; and at least one memory 103 including computer program code 105; wherein the at least one memory 103 and the computer program code 105 are configured to, with the at least one processor 102, cause at least:
displaying visual content on a near eye display 109 detecting an event; and
adjusting, in response to detecting the event, a visual prominence of the displayed visual content for altering a viewer's immersion level in the displayed visual content.

Various examples of the invention can provide the advantage that they cause the prominence of the presentation of the content to be automatically adjusted, thereby altering the viewer's level of immersion of presented content.

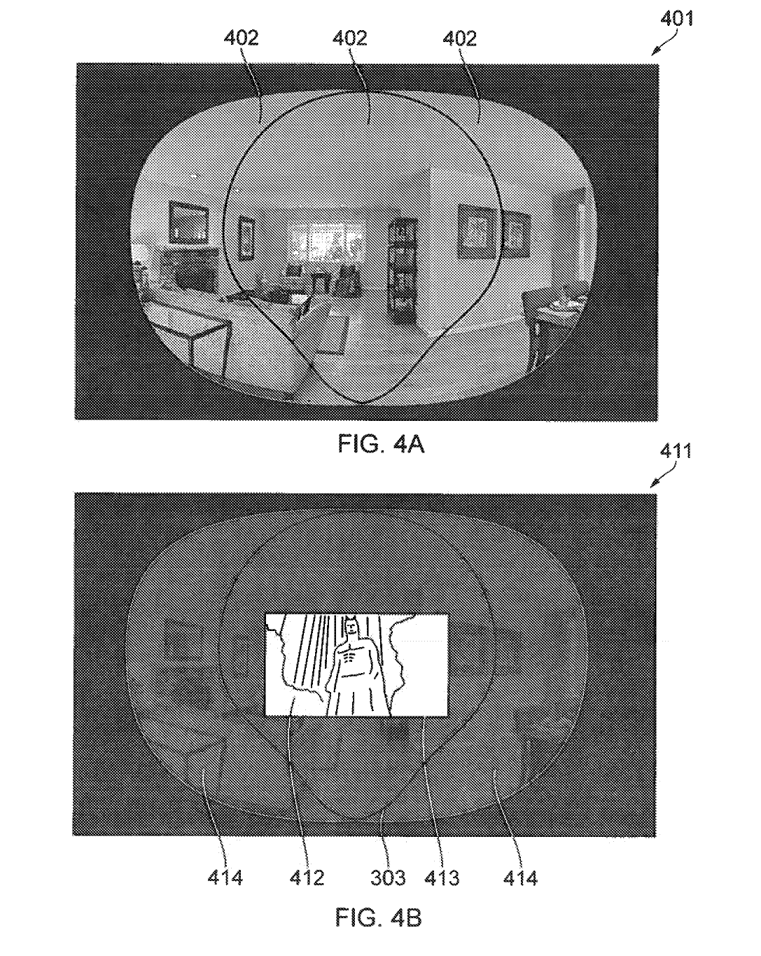

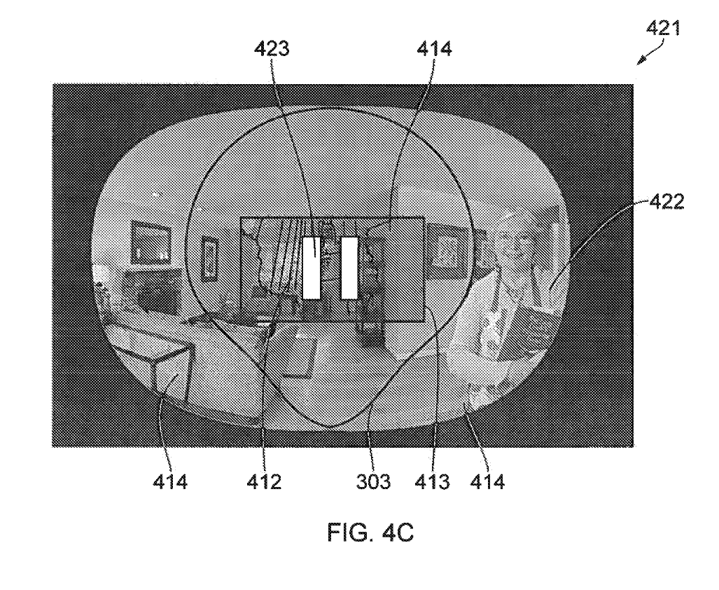

For example, a viewer's level of immersion in content being viewed on a NED can be reduced in response to a real world/external triggering event. With regards to the example of FIG. 4B, a viewer may be immersed in watching a movie on a ‘see through’ NED, wherein the movie content is prominently displayed on the foreground by virtue of its increased brightness and contrast with respect to the background. The apparatus, upon detecting that a person is approaching the viewer, could reduce the prominence of the displayed movie, for example (and as illustrated in FIG. 4C) by:
reducing the brightness and/or contrast of the displayed movie, increasing the relative brightness and/or contrast of the background/real world view (e.g. decreasing an amount of blocking/filtering by adjusting neutral density filtering), and
pausing the audio/visual playback of the movie.

Such actions reduce the prominence of the presentation of the movie, thereby reduce the viewer's immersion level in watching the movie, and increasing the degree to which the ambient real world environment is viewable to the viewer. This facilitates the viewer seeing, interacting and having eye contact with the person without requiring the removal of the NED. Thus, examples of the invention provide automated adaptation of a viewer's immersion level in response to change in the viewer's environment by controlling a NED so as to optimise the use of the NED both when viewing/consuming content as well as when not consuming content. This adds new and convenient functionality to NEDs, as well as improved safety since the viewer can be made more aware of his/her environment. Such advantages facilitate prolonged use/wearing of the NED and reduce the need to remove the NED when not viewing content.

An example of an apparatus for use with a Near Eye Display (NED) will now be described with reference to the Figures. Similar reference numerals are used in the Figures to designate similar features. For clarity, all reference numerals are not necessarily displayed in all figures.

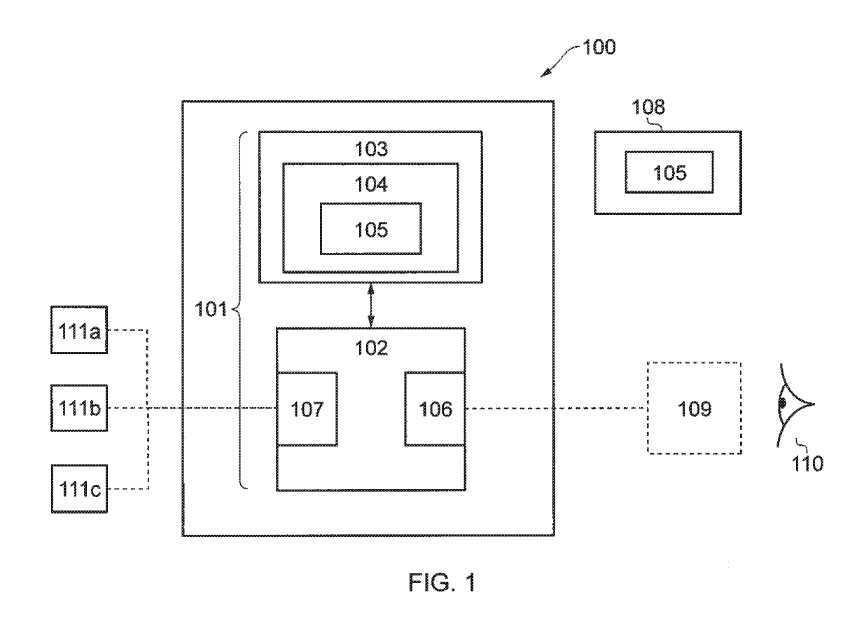

FIG. 1 focuses on the functional components necessary for describing the operation of an apparatus 100. This figure schematically illustrates the apparatus 100 comprising a controller 101 for controlling a NED 109 (shown in outline).

Implementation of the controller 101 can be in hardware alone (e.g. processing circuitry 102 comprising one or more processors and memory circuitry 103 comprising one or more memory elements), have certain aspects in software including firmware alone or can be a combination of hardware and software (including firmware). The controller 101 may be implemented using instructions that enable hardware functionality, for example, by using executable computer program code/instructions 105 in a general-purpose or special-purpose processor 102 that may be stored on a computer readable storage medium (memory circuitry 103 or memory storage device 108) to be executed by such a processor 102.

In the illustrated example, the controller 101 is provided by a processor 102 and a memory 103. Although a single processor 102 and a single memory 103 are illustrated in other implementations there may be multiple processors and/or there may be multiple memories some or all of which may be integrated/removable and/or may provide permanent/semi-permanent/dynamic/cached storage.

The processor 102 is configured to read from and write to the memory 103. The processor 102 may also comprise an output interface 106 via which data and/or commands are output by the processor 102 (for example to the NED 109 as shown in outline) and an input interface 107 via which data and/or commands are input to the processor 102 (for example from sensors 111a-111c as shown in outline).

The memory 103 may store a computer program 104 which comprises the computer program instructions/code 105. The instructions control the operation of the apparatus 100 when loaded into the processor 102. The processor 102 by reading the memory 103 is able to load and execute the computer program 104. The computer program instructions 105 provide the logic and routines that enables the apparatus 100 to perform the methods and actions described below.

The at least one memory 103 and the computer program instructions/code 105 are configured to, with the at least one processor, cause at least:
displaying visual content on a near eye display 109; detecting an event; and
adjusting, in response to detecting the event, a visual prominence of the displayed visual content for altering a viewer's immersion level in the displayed visual content.

A near eye display (NED) 109 is a generic term for display devices configured for near eye use and encompasses, for example, at least the following examples: Head Mountable Displays (HMD) and wearable displays (configured in formats such as: glasses, goggles or helmets). The NED could be of a ‘see though’/transparent type that enables a viewer 110 to see through the NED so as to directly view his/her real world environment and/or allow the transmission of ambient light therethrough. Such a NED permits visual content/virtual image(s) to be displayed in a foreground of the NED's display region whilst the viewer's real world environment/scene is visible in the background of the display region. Such a NED is referred to as ‘optical see through’ type NED.

Alternatively a ‘video see through’ or ‘virtual see through’ type NED could be used which comprises a non-transparent NED configured with an image capturing device to capture images of the viewer's field of view of the real world environment. Such captured images of viewer's viewpoint of his/her surroundings enable a representation of the viewer's real world environment to be displayed in combination with displayed content/virtual image(s).

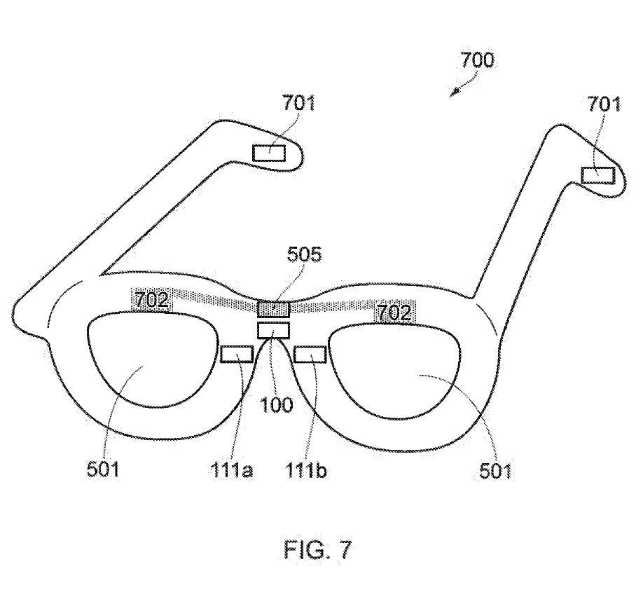

The apparatus 100 could be separate of the NED 109, i.e. provided in separate and distinct devices remote from one another but in wired/wireless communication with one another so that the apparatus can control the NED. For example the apparatus could be provided in a set top box or portable electronic device such as a mobile communications device, whereas the NED could be provided separately as an HMD. Alternatively, the apparatus and the NED could both be provided in the same device, such as the wearable display device glasses 700 of FIG. 7.

The content to be presented could be stored in the memory 103 of the apparatus. Alternatively, the content could be stored remotely of the apparatus, e.g. an external device or server, but accessible to the apparatus via a communication/input interface 107. Yet further, the content could instead be accessible to the NED to display and the apparatus need only control optical/visual characteristics of the NED so as to adjust the NED's presentation of the content. The output interface 106 outputs control signals, and optionally the content for display, to the NED 109. The conveyance of such signals/content from the apparatus 100 to the NED 109 could be via a data bus where the apparatus and NED are provided in the same device, or via wireless or wired communication where they are separate and remote devices.

The computer program code 105 may arrive at the apparatus 100 via any suitable delivery mechanism 108. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program code 105. The delivery mechanism may be a signal configured to reliably transfer the computer program code. The apparatus 100 may propagate or transmit the computer program code 105 as a computer data signal.

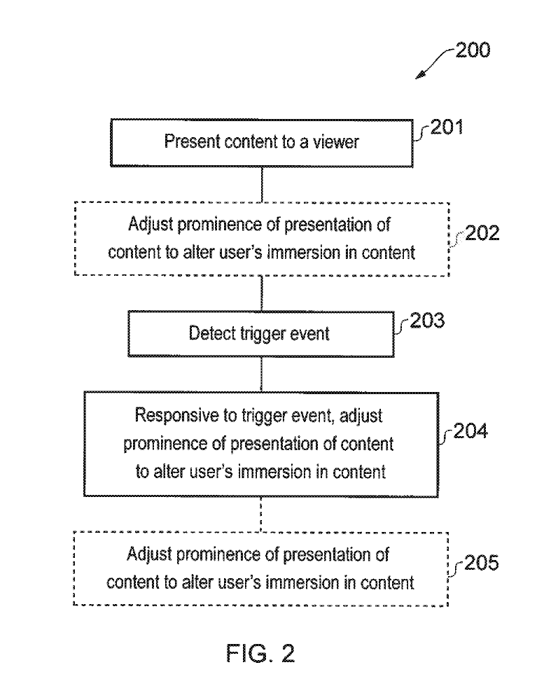

FIG. 2 schematically illustrates a flow chart of a method 200. The component blocks of FIG. 2 are functional and the functions described may or may not be performed by a single physical entity, such as apparatus 100. The blocks illustrated may represent steps in a method and/or sections of code in the computer program 104. The illustration of a particular order to the blocks does not necessarily imply that there is a required or preferred order for the blocks and the order and arrangement of the block may be varied. Furthermore, it may be possible for some blocks to be omitted.

In block 201, the apparatus 100 causes content to be presented to a viewer 110 via a NED 109. The presented content could comprise visual content displayed on the NED, e.g. image(s), video, a graphical user interface or visual content from a software application and/or a game. Also the presented content could comprise audio content output from at least one audio output device (not shown). The at least one audio output device could be provided as device(s) separate and distinct from the apparatus 100 and NED 109 or alternatively the at least one audio output device could be combined and housed in a single device such as the apparatus 700 of FIG. 7.

In block 203 a triggering event is detected. The triggering event may be a real world physical event and could comprise at least one of:
detecting a change in the real world environment, e.g. movement of an object in the vicinity of the viewer/NED;
detecting a movement of the viewer, e.g. movement of a body portion such as fingers, hands, limbs, head and eyes;
detecting a change in the viewer's gaze direction;
detecting movement of the NED, and
detecting a sound, such as ambient/external sounds separate from the outputted audio content.

The input interface 107 can receives signals from one or more sensors 111a, 111b and 111c (shown in outline in FIG. 1) variously configured to detect the above mentioned triggering events. The sensors 111a-c may include one or more of: a motion detector, an image capturing device/camera, an audio capturing device/microphone accelerometer, magnetometer, eye gaze/direction tracker, sonar, and radar based detectors. The conveyance of sensor signals to the apparatus 100 could be via a data bus where the sensors 111a-c and the apparatus 100 are provided in the same device, or via wireless or wired communication where they are separate and remote devices.

In block 204, in response to detection of the triggering event, the apparatus causes the prominence of the displayed content to be adjusted so as to alter the viewer's immersion in the presented content.

With regards to visual content, causing the adjustment of the prominence of the display of visual content could comprise causing:
adjusting the optics or a visual filter of the NED so as to selectively adjust the transparency and/or opacity of the NED;
adjusting a visual attribute or display characteristic of the displayed visual content, e.g. a brightness level or contrast level; adjusting the visual content displayed; such as pausing or slowing down a playback of the displayed visual content; and
displaying a visual notification, e.g. a visual alert or message.

For a video or optical see through NED, visual content could be displayed over background visuals corresponding to at least a partial view of the viewer's real world environment, i.e. real world ambient visuals and/or ambient light corresponding to the viewer's field of view. Increasing display brightness or adding neutral density filtering behind transparent display elements of the see through NED are some possible options to adjust the prominence of the displayed visual content so as to emphasize the foreground displayed content the relative to the background and thus increasing a level of immersion in the displayed content.

The adjustment of the prominence of the display of visual content could comprise:
adjusting the prominence of the visual content displayed relative to the viewable background;
adjusting a visual attribute or display characteristic of the visual content displayed relative to viewable background; e.g. a brightness level or contrast level;
blocking the background, for example via mechanical shutters or adjusting opacity of a NED device to block the real world ambient visuals/scene being visible therethrough; and
adjusting the level of ambient light transmissible through the NED.

With regards to audio content, an adjustment of the prominence of the audio content output could comprise:
adjusting the prominence of the audio content output relative to an ambient sound level of the viewer's real world environment;
adjusting the audio content output; such as pausing a playback of the audio content output;
adjusting an audial attribute or audio characteristic of the audio content output, e.g. attenuation of output audio content, adjustment of volume, adjusting an audio filter, e.g. attenuation of audio content output, use of noise cancellation to reduce ambient noise;
outputting an audio notification, e.g. alert sound.

When the viewer is immersed in the presentation of the content, e.g. after block 202 discussed below, upon detection of a triggering event, the apparatus could reduce the viewer's immersion by:
decreasing the brightness and contrast level of the displayed visual content;
increasing the brightness and contrast level of the background visuals;
enhancing the viewer's perception of ambient noise, e.g. by decreasing the volume of the audio content output.

Additionally, the prominence of the presented content could be further diminished by:
pausing playback of the audio/visual content;
slowing down a playback of the visual content;
displaying a visual notification; and
outputting an audio notification.

In one particular example, the content could relate to a First Person Shooter (FPS) game wherein the game's visual content is displayed to a player via an HMD worn by the player. The FPS game may enables head tracking such that the player's view within the game rotates and moves in correspondence with rotation/movement of the player's head. Upon detection of a triggering event, the player's level of immersion in the game could be adjusted, for example by causing a partial pausing in the game play, for example by causing opponents in the game to freeze but maintain other game functionality such as maintaining head tracking.

Causing the above mentioned adjustments to the presented content enables the provision of a NED display mode more suited to viewing/interacting with the viewer's real world environment.

The method 200 also shows (in outline) optional block 202 wherein the apparatus could adjust prominence of presentation of content to alter viewer's immersion in content. For example, prior to block 204's adjustment in response the triggering event (which may be a reduction in prominence of the presented content to reduce a viewer's immersion in the content), in block 202, in response to initiating the presentation of content, there could be an increase in prominence of the presented content to increase a viewer's immersion in the content. Causing such adjustments enables the provision of a NED display mode more suited to viewing displayed content. For example, prominence of the presented content could be increased by:
increasing the brightness and contrast level of the displayed visual content;
reducing the brightness and contrast level of the background visuals;
increasing the volume of the outputted audio content;
reducing ambient noise, e.g. by using a noise cancellation filter.

Likewise, after block 204's adjustment, in optional block 205 (shown in outline), there could be further adjustment of the prominence of the presentation of content to alter the viewer's immersion in content. For example, after a reduction in the prominence of the presented content to reduce a viewer's immersion in the content in response the triggering event (block 204), there could be an increase in prominence of the presented content to increase a viewer's immersion in the content. Such a further re-adjustment could be effected in response to a further triggering event, removal of the triggering event of block 203, a viewer command/input or upon expiration of a pre-determined period of time, so as to restore previous conditions and/or reverting back to a display mode optimized for viewing content.

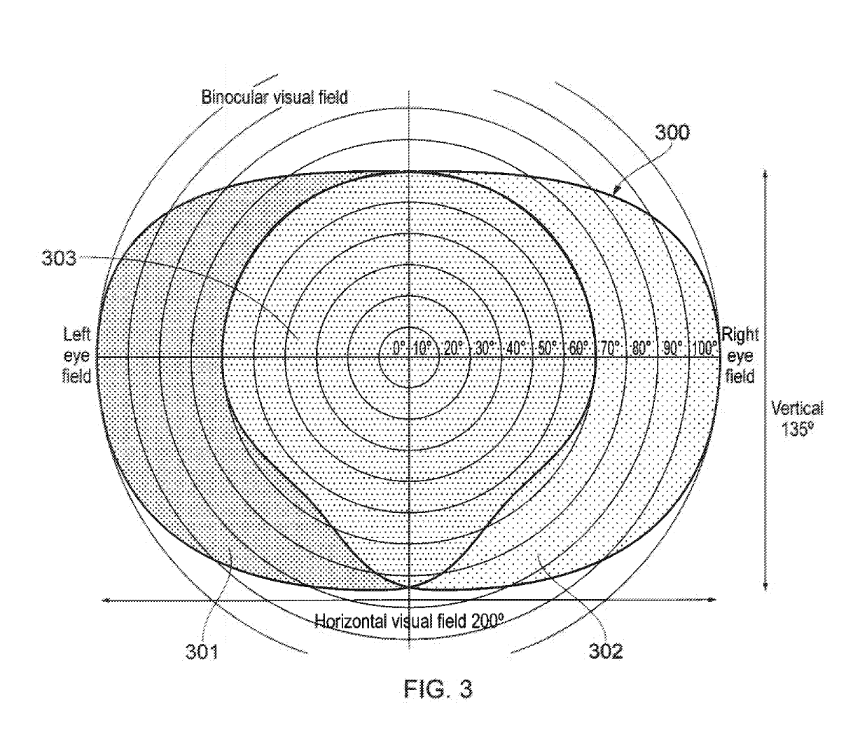

FIG. 3 illustrates an example of a viewer's binocular visual field 300. This shows the viewer's left eye visual field 301 and right eye visual field 302. A central region 303 relates to where the left and right visual fields overlap. The apparatus and/or the NED may be configured such that the display of visual content is presented to the viewer in this overlapping central region 303 of the viewer's visual field 300.

FIG. 4A illustrates an example of viewer's view when wearing a see through head mounted/head mountable NED device under control of the apparatus 100 so as to be in a first mode of operation 401. In this example the NED is of an optical see through type. In this first mode 401, no content is presented to the viewer and the NED is controlled by the apparatus so as to be optimised viewing of the real world background, e.g. maximal transparency/minimal opacity of the display region of the NED. One could consider such a mode as relating to a lowest level of immersion of content or no immersion in the content. The viewer, whilst wearing the NED, is optimally able to see, interact with and be aware of his/her real word environment 402.

FIG. 4B illustrates an example of viewer's view in a second mode 411 of operation, e.g. after performance of method blocks 201 and 202. In the second mode 401, visual content 412, in this case a movie, is displayed within a virtual screen 413 positioned so as to be visible at a central portion 303 of the viewer's visual field. The NED 109 is controlled by the apparatus 100 so as to be optimised for viewing content by increasing the prominence of the visual content relative to the background. For example by causing an increase in the brightness and/or contrast of the displayed content 412 and causing a decrease in the brightness of the background visuals 414. Likewise, the prominence of the movie's audio could be enhanced by using noise cancellation to minimise ambient sounds. Such actions, in effect, reduce ‘visual noise’ and ‘audio noise’, i.e. unwanted visuals and sounds, and can be thought of as increasing the signal to noise ratio of the presented content verses background sights and sounds. One could consider the second mode to relate to a ‘normal’ viewing mode optimised for consuming content providing increased, complete or full immersion compared to the third mode 421 of FIG. 4C.

FIG. 4C illustrates an example of a viewer's view of a third mode 421 of operation of the NED after performance of method block 204 following a triggering event. Here, the triggering event is the detection of a change in the viewer's real world environment. For example detecting movement of an object 422 in the real world environment which in this case corresponds to detecting a person 422 approaching the viewer. Alternatively, the triggering event could be detecting the viewer's gaze departing from being directed and focused on the central region 303 and changing direction towards a peripheral edge of the viewer's visual field, i.e. the viewer's eyes moving to look at and focus upon a person 422 in the peripheral edge of the viewer's visual field. Yet further alternatively, the triggering event could be detecting the viewer's head moving, e.g. turning to look at the person 422, and/or the movement of the NED device itself which is worn by the viewer.

In the third mode 421 the NED 109 is controlled by the apparatus 100 so as to facilitate viewing/interaction with the viewer's real world environment during the presentation of content. The prominence of the visual content relative to the background is reduced, for example by causing a decrease in the brightness and/or contrast of the displayed content 412 and causing an increase in the brightness of the background visuals 414. Likewise, the prominence of the movie's audio could be reduced by removing the noise cancellation and/or lowering the volume of the movie's audio. Optionally, the audio/visual playback could be paused and a visual notification 423, in this case a pause symbol, could be displayed. Such actions, in effect, enable the viewer to be more aware of his/her real-world environment. The third display mode enables an increase in a viewer's awareness/perception of his/her real-world environment. One could consider the third mode to relate to a ‘reduced immersion’ viewing mode relative to the normal content viewing mode of FIG. 4B.

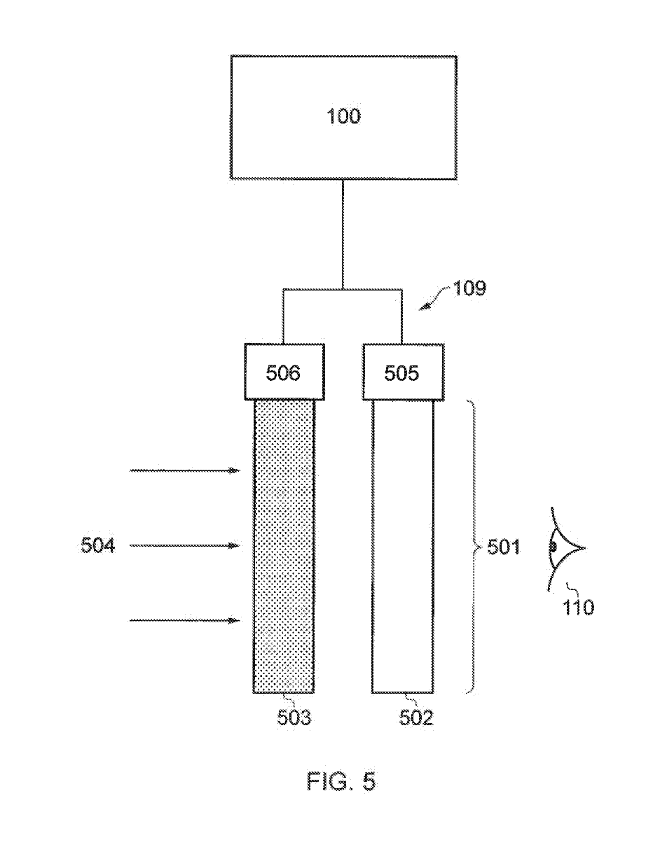

The NED 109 could comprise a display region 501 via which visual content is displayed on a first portion 502 and a second portion 503 through which background visuals of the viewer's real world environment are viewable. FIG. 5 schematically illustrates an example of a display region 501 of a NED 109. The NED is in communication with an apparatus 100 as described above which controls the NED and the optical properties/visual filter of the display region. In the example shown, the NED is of a see through type in that both the first portion 502 of the display area and the second portion of the display area are selectively transparent to selectively permit the transmission therethrough of ambient light and background visuals (represented by arrows 504) to the viewer 110.

The display of visual content on the NED could be effected via any suitable display means, such as a micro display and optics 505 whose output is guided and expanded for display to a viewer 110, for example via a diffractive exit pupil expander acting as a light guide. The adjustable visibility of the background/ambient light through the NED could be effected via any suitable means, such as adjustable optics, a visual filter or means for adjusting the transparency and/or opacity of the NED. For example, the second portion 503 could comprise an electrically controllable visual filter such as involving an liquid crystal (LC) layer acting as a selectable shutter driven by an LC driver. Alternatively the second portion could comprise a mechanically actuatible shutter driven by an actuator mechanism 506.

The apparatus 100, by controlling both the display of foreground content from the first portion 502 as well as the visibility of the background 504 through the second portion 503, which then passes through the first portion, can adjust prominence of the displayed visual content thereby possibly altering the viewer's immersion in the presented content.

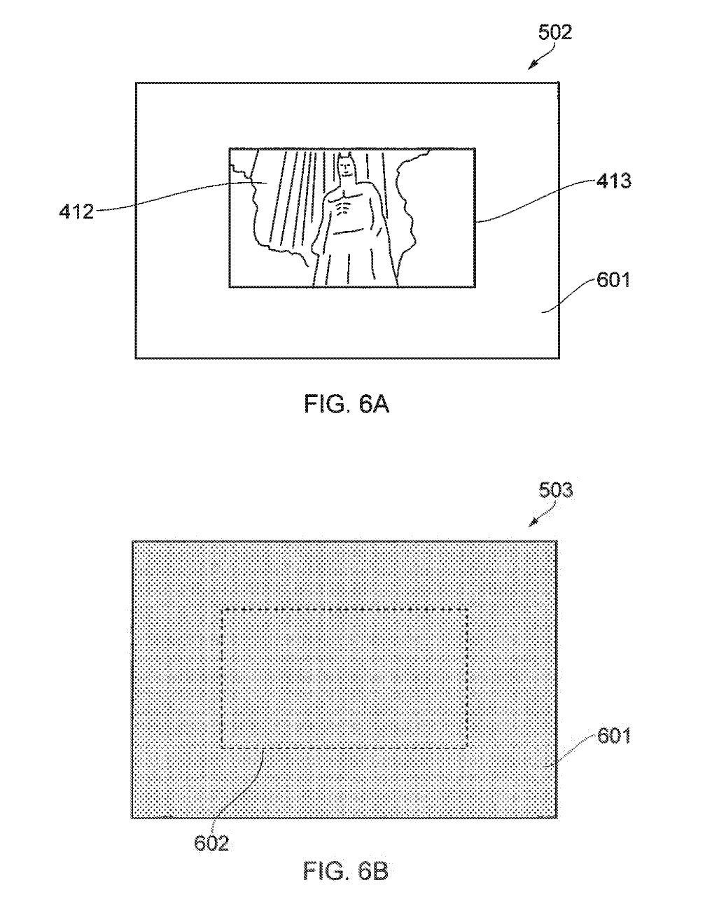

FIGS. 6A and 6B schematically illustrate an example of the display of the first portion 502 and view of the second portion 503 of the display region 501 of the NED 109 of FIG. 5 when in the ‘normal’/‘fully immersed’ second viewing mode 411 of FIG. 4B.

In FIG. 6A, the visual content 412 is presented in a virtual screen 413 in a substantially central portion of the display area 601 of the first portion 502. The displayed visual content could be pre-determined and unrelated to objects in the viewer's real-world environment. The position and location of the virtual screen 413 in relation to the display area 601 remains constant/fixed irrespective of any change in the viewer's field of view, i.e. the location of the displayed content does not constantly move about the display area so as to follow and maintain registration of the location of the virtual image(s) with the viewer's viewpoint of the real-world scene so as to keep the virtual image in alignment with objects in the real world.

In FIG. 6B, the second portion 503 is configured to be at least partially opaque and or only partially transparent so as to block or reduce the visibility of the background 504 visible to the viewer 109 therethrough, thereby increasing the prominence of the displayed content 412 relative to the obscured background view of the real world.

The adjustment of visual characteristics (such as levels of transparency, opacity, brightness, contrast) viewable from each of the first and second portions can be performed over the entirety of the display area 601 of each of the first and second portions. Alternatively one or more sub-portions of the display area may be adjusted. For example, instead of adjusting the transparency/opacity of the second portion 503 over its entire area 601, one or more sub portion areas 602 could be adjusted, e.g. to reduce/block out light in an area 602 corresponding to the area of the virtual screen 413 of the first portion 502. This enables a selective adjustment of the amount of ambient light/background visuals viewable within the vicinity of the displayed content, and/or a selective adjustment of the amount of ambient light/background visuals viewable outside of the area of the virtual screen.

Although the example of FIGS. 5, 6A and 6B shows the control of the prominence of the displayed visual content via control of separate first and second portions of the display region 501, the display region could comprise a single portion controlled by the apparatus 100. For example, with respect to FIG. 6A, the display portion 502 could be configured such that the transparency/opacity of the background area surrounding the virtual screen could be selectively adjusted.

FIG. 7 schematically illustrates an example of a wearable device 700 configured as in the form of glasses/goggles. The device comprises an apparatus 100 and a NED as previously described along with two audio output devices, i.e. speakers 701.

An output from one or more micro displays 505 is guided via light guides 702 to diffractive exit pupil expanders to output a visual display to the left and right eye display regions 501. Sensors 111a and 111b are provided on the device to detect a triggering event which causes the adjustment of the prominence of the displayed visual content thereby altering the viewer's immersion in the presented content.

A binocular display device as shown would be more suitable for prolonged use. However, the device could instead be configured as a monocular display device.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.”

As used here ‘module’ refers to a unit or apparatus that excludes certain parts/components that would be added by an end manufacturer or a user.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
at least one processor; and
at least one memory including computer program code;
wherein the at least one memory and the computer program code are configured to, with the at least one processor, cause at least:
displaying visual content on a near eye display;
detecting an event; and
adjusting, in response to detecting the event, a visual prominence of the displayed visual content for altering a viewer's immersion level in the displayed visual content.

2. The apparatus according to claim 1, wherein adjusting the visual prominence of the displayed visual content comprises at least one of:
adjusting a visual filter of the near eye display;
adjusting optical properties of the near eye display;
adjusting the displayed visual content;
adjusting a visual attribute of the displayed visual content;
displaying a visual notification.

3. The apparatus according to claim 1, wherein the at least one memory and the computer program code are further configured to, with the at least one processor, cause adjusting the visual prominence of the displayed visual content relative to a background of the displayed visual content.

4. The apparatus of claim 3, wherein the background of the displayed visual content comprises at least a partial view of the viewer's real world environment provided by the near eye display.

5. The apparatus according to claim 3, wherein adjusting the visual prominence of the displayed visual content comprises at least one of:
adjusting the visual prominence of the background relative to the displayed visual content;
adjusting a visual attribute of the background;
adjusting the level of ambient light viewable by the viewer through the near eye device; and
blocking a view of the background.

6. The apparatus according to claim 1, wherein detecting an event comprises at least one of:
detecting a change in the real world environment;
detecting movement of the viewer;
detecting a change in the viewer's gaze direction;
detecting movement of the near eye display, and
detecting a sound.

7. The apparatus according to claim 1, wherein the near eye display is configurable to be at least partially transparent so as to enable the viewer to see therethrough, and wherein adjusting the visual prominence of the visual content displayed comprises adjusting a transparency level of at least a part of the near eye display.

8. The apparatus according to claim 1, wherein the near eye display is configured to provide adjustable levels of opacity so as to adjustably allow the transmission of ambient light therethrough, and wherein adjusting the visual prominence of the visual content displayed comprises adjusting an opacity level of at least a part of the near eye display.

9. The apparatus according to claim 1, wherein the at least one memory and the computer program code are further configured to, with the at least one processor, cause:
outputting audio content from at least one audio output device; and
adjusting, in response to detecting the event, a prominence of the audio content output for altering a viewer's immersion level in the audio content output.

10. The apparatus according to claim 9, wherein the at least one memory and the computer program code are further configured to, with the at least one processor, cause adjusting the prominence of the audio content output relative to an ambient sound level of the viewer's real world environment.

11. The apparatus according to claim 9, wherein adjusting the audial prominence of the audio content output comprises at least one of:
adjusting an audio filter of the at least one audio output device;
adjusting the audio content output;
adjusting an audial attribute of the audio content output;
adjusting a volume level of the audio content output; and
outputting an audio notification.

12. A chipset comprising the apparatus according to claim 1.

13. A module comprising the apparatus according to claim 1.

14. A near eye display comprising the apparatus according to claim 1.

15. A method comprising causing actions that result in:
displaying visual content on a near eye display;
detecting an event; and
adjusting, in response to detecting the event, a visual prominence of the displayed visual content for altering a viewer's immersion level in the displayed visual content.

16. The method according to claim 15, further comprising adjusting the visual prominence of the displayed visual content relative to a background of the displayed visual content.

17. The method according to claim 15, wherein the near eye display is configurable to be at least partially transparent so as to enable the viewer to see therethrough, and wherein adjusting the visual prominence of the visual content displayed comprises adjusting a transparency level of at least a part of the near eye display.

18. The method according to claim 15, wherein the near eye display is configured to provide adjustable levels of opacity so as to adjustably allow the transmission of ambient light therethrough, and wherein adjusting the visual prominence of the visual content displayed comprises adjusting an opacity level of at least a part of the near eye display.

19. The method according to claim 15, further comprising:
outputting audio content from at least one audio output device; and
adjusting, in response to detecting the event, a prominence of the audio content output for altering a viewer's immersion level in the audio content output.

20. A computer program product comprising a non-transitory computer-readable medium bearing computer program code embodied therein for use with a computer, the computer program code comprising:
code for displaying visual content on a near eye display;
code for detecting an event; and
code for adjusting, in response to detecting the event, a visual prominence of the displayed visual content for altering a viewer's immersion level in the displayed visual content.
